(19) United States
(12) Patent Application Publication
(10) Pub. No.: US 2023/0031946 A1
(43) Pub. Date: Feb. 2, 2023

(54) DRIVING METHOD OF ARRAY SUBSTRATE, ARRAY SUBSTRATE, AND DISPLAY PANEL

(71) Applicants: BEIHAI HKC OPTOELECTRONICS TECHNOLOGY CO., LTD., Beihai (CN); HKC CORPORATION LIMITED, Shenzhen (CN)

(72) Inventors: CHIH TSUNG KANG, Beihai (CN); Haijiang YUAN, Beihai (CN)

(73) Assignees: BEIHAI HKC OPTOELECTRONICS TECHNOLOGY CO., LTD., Beihai (CN); HKC CORPORATION LIMITED, Shenzhen (CN)

(21) Appl. No.: 17/876,879

(22) Filed: Jul. 29, 2022

(30) Foreign Application Priority Data
Jul. 30, 2021 (CN) 202110878219.1

(51) Int. Cl. G09G 3/36

(52) U.S. Cl. CPC G09G 3/3614; G09G 2300/0426; G09G 2300/0452; G09G 2300/0842; G09G 2310/08; G09G 2320/0233; G09G 2320/0626

(57) ABSTRACT

Disclosed are a driving method of an array substrate, an array substrate and a display panel. The array substrate includes a plurality of sub-pixels, a plurality of row scan drive signal lines, a plurality of data drive signal lines and a plurality of common electrode signal lines. The plurality of sub-pixels are arranged in an array, each row of sub-pixels are divided into a first pixel group and a second pixel group. The sub-pixels of the first pixel group and the second pixel group are arranged alternately in the row. Each of the data drive signal line is provided between two columns of sub-pixels of each group, and electrically connected to each sub-pixel of two columns of sub-pixels of each group. Each of the data drive signal lines is provided between the two columns of sub-pixels of each group.

### CROSS-REFERENCE TO RELATED APPLICATIONS

The present application claims priority to Chinese Patent Application No. 202110878219.1, titled "Driving Method of Array Substrate, Array Substrate and Display Panel" and filed on Jul. 30, 2021, which is hereby incorporated for reference in its entirety for all purposes.

### TECHNICAL FIELD

The present application relates to the technical field of an array substrate, and in particular to a driving method of an array substrate, an array substrate and a display panel.

### BACKGROUND

A driving principle of the array substrate in the related art is generally polarity inversion drive, that is, a position relationship of the liquid crystal molecules is changed dependent on a change of the voltage, the polarity inversion drive is to apply a voltage signal whose positive polarity and negative polarity are changed to liquid crystal molecules to achieve an alternative current drive of the liquid crystal molecules. The polarity inversion drive includes a row inversion drive, a column inversion drive, a frame inversion drive and a point inversion drive, and so on.

The present application is proposed based on the polarity inversion. When a row of pixel units are driven by two rows of row scan lines, since the drive time of the array substrate keeps unchanged, and it is scanned by the row scan lines row by row, thus the scan drive time of each row of the pixel units is reduced by half. That is, the charging time of each of the pixel units is reduced by half. The polarity drive of sub-pixel signal in the same data drive signal line is switched to the reverse polarity. Since the load effect is caused by the parasitic capacitance effect generated by the data drive line and other electrodes, when the polarity drive of the data drive signal line is switched to reverse polarity, the load effect makes the signal of the data drive signal line not reach the required reverse polarity voltage immediately, thus there is a voltage response time. As shown in FIG. 3, the charging time TDₙ₊₁₋ₘ of the sub-pixel is the same as the charging time TDₙ₊₂₋ₘ of the sub-pixel Vpₙ₊₂₋ₘ, that is TDₙ₊₁₋ₘ=TDₙ₊₂₋ₘ, but since the charging signal of the sub-pixel is switched from the positive polarity signal VD₁ (Vpₙ₋ₘ sub-pixel) of the data drive line VDₘ to the negative polarity signal VD₂ (Vpₙ₊₁₋ₘ sub-pixel) relative to the common electrode signal V_{com}. The parasitic capacitance effect produces a load effect to form different equivalent charging signals in the same charging time TDₙ₊₁₋ₘ=TDₙ₊₂₋ₘ. As shown in FIG. 3, if adjacent sub-pixels are charged with two opposite polarities respectively, the sub-pixel is undercharged, the brightness of the sub-pixel decreases, and one bright row of sub-pixels and one darker row of sub-pixels are seen in space.

### SUMMARY

The main purpose of the present application is to propose a driving method of an array substrate, aiming to solve a technical problem that bright and darker streaks are easily happened on display panels.

In order to achieve the above purpose, the present application provides a driving method of an array substrate, including:
a plurality of sub-pixels arranged in an array;
wherein each row of sub-pixels comprises a first pixel group and a second pixel group, sub-pixels of the first pixel group and sub-pixels of the second pixel group are arranged alternately in the row, each row of sub-pixels has a first row scandrive signal line and a second row scan drive signal line, wherein in a same row, the first row scan drive signal line is electrically connected to the first pixel group and the second row scan drive signal line is electrically connected to the second pixel group;
wherein each column of sub-pixels comprises a third pixel group and a fourth pixel group, sub-pixels of the third pixel group and the fourth pixel group are arranged alternately in the column, a data drive signal line is electrically connected to the third pixel group and the fourth pixel group of each column;
wherein sub-pixels of the first pixel group and sub-pixels of the third pixel group are of a first polarity and sub-pixels of the second pixel group and sub-pixels of the fourth pixel group are of a second polarity;
wherein the driving method of the array substrate includees:
   controlling the data drive signal line to output a first polarity data drive signal in a first time period and a fourth time period, and output a second polarity data drive signal in a second time period and a third time period;
   outputting the first polarity data drive signal to drive the sub-pixels of the first pixel group in the first time period;
   outputting the second polarity data drive signal to drive the sub-pixels of the second pixel group in the second time period;
   outputting the second polarity data drive signal to drive the sub-pixels of the first pixel group in the third time period;
   outputting the first polarity data drive signal to drive the sub-pixels of the second pixel group in the fourth time period; or
   the driving method of the array substrate comprising:
   controlling the data drive signal line to output the first polarity data drive signal in the first time period and the second polarity data drive signal in the second time period;
   outputting the first polarity data drive signal to drive the sub-pixels of the first pixel group in the first time period;
   outputting the second polarity data drive signal to drive the sub-pixels of the second pixel group in the second time period.

In one embodiment, the outputting the first polarity data drive signal to drive the sub-pixels of the first pixel group includes, driving the sub-pixels of the first pixel group of each row in turn along an extension direction of the data drive signal line.

In one embodiment, the outputting the second polarity data drive signal to drive the sub-pixels of the second pixel group includes, driving the sub-pixels of the second pixel group of each row in turn along an extension direction of the data drive signal line.

In one embodiment, when the data drive signal line is controlled to output the first polarity data drive signal in the first time period and the fourth time period, and output the second polarity data drive signal in the second time period and the third time period, time spans of the first time period, the second time period, the third time period and the fourth time period are equal; or when the data drive signal line is controlled to output the first polarity data drive signal in the first time period and the second polarity data drive signal in the second time period, time spans of the first time period and the second time period are equal.

In order to achieve the above purpose, the present application provides an array substrate, the array substrate includes a memory storing a driving program of the array substrate;
a processor for executing the driving program of the array substrate to realize the driving method of the array substrate according to claim 1; and
a plurality of sub-pixels arranged in an array;
wherein each row of sub-pixels comprises a first pixel group and a second pixel group, sub-pixels of the first pixel group and sub-pixels of the second pixel group are arranged alternately in the row, each row of sub-pixels has a first row scan drive signal line and a second row scan drive signal line, wherein in a same row, the first row scan drive signal line is electrically connected to the first pixel group and the second row scan drive signal line is electrically connected to the second pixel group;
wherein each column of sub-pixels comprises a third pixel group and a fourth pixel group, sub-pixels of the third pixel group and the fourth pixel group are arranged alternately in the column, a data drive signal line is electrically connected to the third pixel group and the fourth pixel group of each column;
wherein sub-pixels of the first pixel group and sub-pixels of the third pixel group are of a first polarity and sub-pixels of the second pixel group and sub-pixels of the fourth pixel group are of a second polarity.

In one embodiment, the array substrate further comprises a plurality of data drive signal lines, the plurality of the sub-pixels are divided into a plurality of groups by two adjacent columns of sub-pixels as a group, each of the data drive signal lines is provided between two columns of sub-pixels of each group and electrically connected to each sub-pixel of the two columns of sub-pixels of each group.

In one embodiment, the array substrate further includes a plurality of common electrode signal lines, each of the common electrode signal lines is provided between two adjacent groups of sub-pixels;

wherein in each column of sub-pixels, a common electrode storage capacitance Cst is formed by each sub-pixel and an adjacent common electrode signal line.

In one embodiment, one terminal of the common electrode storage capacitor is connected to the common electrode signal line, and the other terminal of the common electrode storage capacitor is connected to a pixel electrode of the sub-pixel.

In one embodiment, on a row of sub-pixels of the array substrate, three sub-pixels form a pixel unit, the three sub-pixels area red sub-pixel, a green sub-pixel and a blue sub-pixel in turn, wherein one of a data drive signal line and a common electrode signal line is provided between the red sub-pixel and the green sub-pixel, and the other of the data drive signal line and the common electrode signal line is provided between the blue sub-pixel and the green sub-pixel.

In one embodiment, when there is a plurality of the pixel units, one of the data drive signal lines and the common electrode signal lines is provided between the red sub-pixel of the next pixel unit and the blue sub-pixel of the current pixel unit.

In order to achieve the above purpose, the present application provides a display panel, including a color film substrate, a liquid crystal, and an array substrate as mentioned above, the array substrate, the liquid crystal, and the color film substrate are stacked in turn.

The array substrate of the technical solution of the present application includes a plurality of sub-pixels arranged in an array. Each row of sub-pixels is divided into the first pixel group and the second pixel group. The sub-pixels of the first pixel group and the second pixel group are arranged alternately along rows where they are located. Each row of sub-pixels has a first row scan drive signal line and a second row scan drive signal line. In a same row, the first row scan drive signal line is electrically connected to the first pixel group, and the second row scan drive signal line is electrically connected to the second pixel group. Each column of sub-pixels is divided into a third pixel group and a fourth pixel group. The sub-pixels of the third pixel group and the fourth pixel group are arranged alternately along columns where they are located. Each of data drive signal lines is electrically connected to the third pixel group and the fourth pixel group of each column. The sub-pixels of the first pixel group and the third pixel group are of sub-pixels of a first polarity, the sub-pixels of the second pixel group and the fourth pixel group are of sub-pixels of a second polarity. The driving method of the array substrate is realized based on the array substrate. First, the control method of the array substrate controls the data drive signal line to output a first polarity data drive signal in a first time period and a fourth time period, and output a second polarity data drive signal in a second time period and a third time period. The first polarity data drive signal is output to drive the sub-pixels of the first pixel group in the first time period. The second polarity data drive signal is output to drive the sub-pixels of the second pixel group in the second time period. The second polarity data drive signal is output to drive the sub-pixels of the first pixel group in the third time period. The first polarity data drive signal is output to drive the sub-pixels of the second pixel group in the fourth time period. According to the above solution, the sub-pixels of the third pixel group and the fourth pixel group of each column, connected to the data drive signal lines, are driven in the different time period, so that only the sub-pixels of the same polarity are driven in a certain time period. The arrangement of sub-pixels of the first polarity and the second polarity is combined with the driving solution to ensure the charging time for completely charging. One bright row of sub-pixels and one darker row of sub-pixels are avoided. The bright and dark streaks easily produced on the display panel are avoided.

### BRIEF DESCRIPTION OF THE DRAWINGS

In order to more clearly explain the embodiments of the present application or the technical solutions in the related art, the following will briefly introduce the drawings in the embodiments or the description of the related art. It is obvious that the drawings described below are only some embodiments of the present application. For those skilled in the art, other drawings can be obtained according to the structure shown in these drawings without paying creative labor.

FIG. 1 is a flowchart of a driving method of an array substrate according to the present application.

FIG. 2 is a structural diagram of the array substrate according to the present application.

FIG. 3 is a schematic diagram of a driving timing of the array substrate in the exemplary technology.

FIG. 4 is a schematic structural diagram of the array substrate according to the present application.

FIG. 5 is a schematic diagram of an equivalent circuit of a structure of the array substrate according to the present application.

FIG. 6 is a flowchart of a driving timing of the array substrate according to the present application.

FIG. 7 is a schematic structural diagram of the driving method of the array substrate according to the present application.

FIG. 8 is a schematic structural diagram of the array substrate according to the present application.

The realization of the purpose, functional features and advantages of the present application will be further described in conjunction with the embodiments, with reference to the accompanying drawings.

### DETAILED DESCRIPTION OF THE EMBODIMENTS

The technical solution in the embodiment of the present application will be clearly and completely described below in combination with the accompanying drawings in the embodiment of the present application. If there are descriptions involving "first", "second" and so on in the embodiment of the present application, the descriptions of "first", "second" and so on are only for descriptive purposes, and cannot be understood as indicating or implying its relative importance or implicitly indicating the number of indicated technical features. Thus, the features defined with "first" and "second" can include at least one of the features explicitly or implicitly.

The present application proposes an array substrate to solve a technical problem that light and dark streaks are easily produced on display panels.

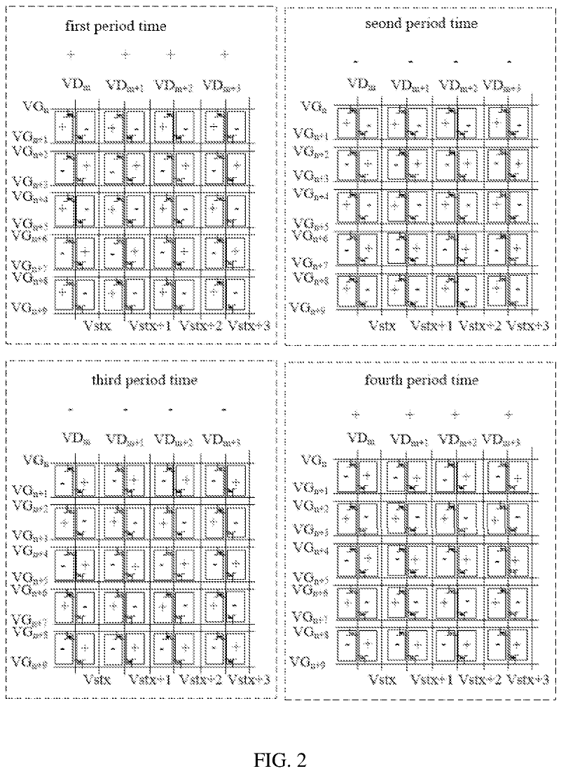

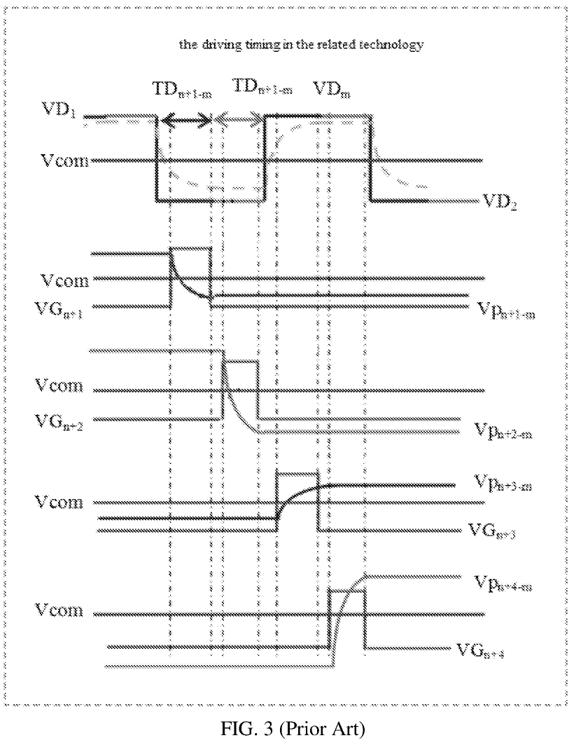

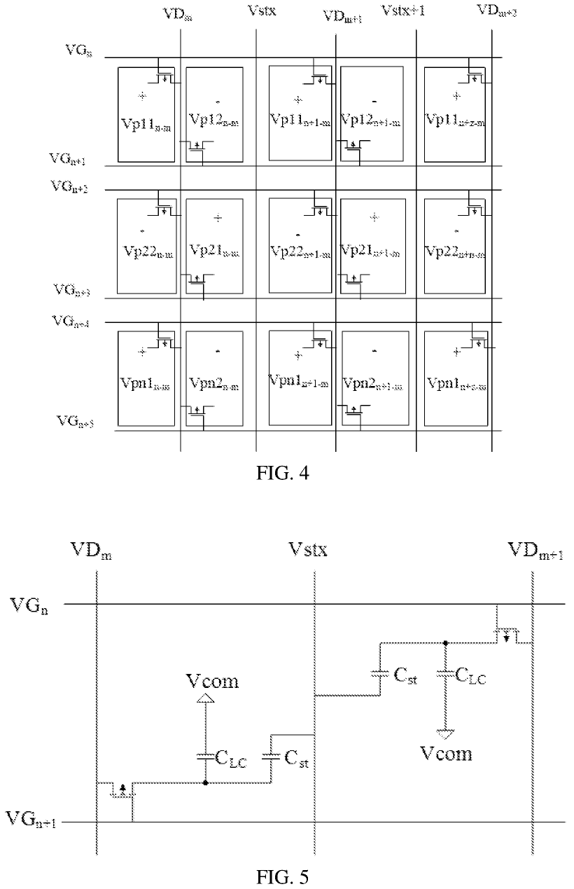

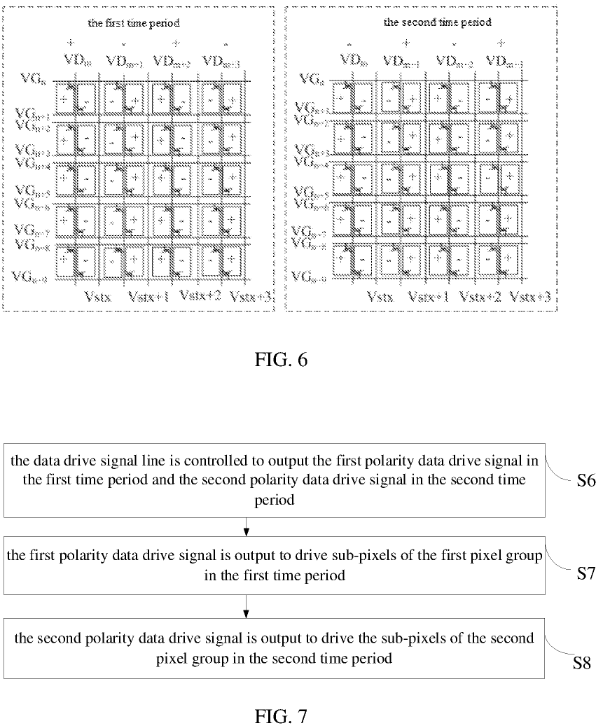

In one embodiment, the solution of the present application is realized based on an array substrate. As shown in FIGS. 2 and FIG.4, the array substrate includes a plurality of sub-pixels arranged in an array. As shown in FIG. 4, each row of sub-pixels is divided into a first pixel group (Vp11ₙ₋ₘ, Vp11ₙ₊₁₋ₘ ...., Vp11_{n+z-m}/Vp21ₙ₋ₘ, Vp21ₙ₊₁₋ₘ ...., Vp21_{n+z-m}/Vpn1ₙ₋ₘ, Vpn1ₙ₊₁₋ₘ...., Vpn1_{n+z-m}) and a second pixel group (Vp12ₙ₋ₘ, Vp12ₙ₊₁₋ₘ ...., Vp12_{n+z-m}/Vp22ₙ₋ₘ, Vp22ₙ₊₁₋ₘ...., Vp22ₙ₊ₙ₋ₘ/Vpn₂ₙ₋ₘ, Vpn2ₙ₊₁₋ₘ...., Vpn2_{n+z-m}). The sub-pixels of the first pixel group and the second pixel group are arranged alternately along rows where they are located. Each row of sub-pixels has a first row scan drive signal line and a second row scan drive signal line. In a row, the first row scan drive signal line (VGₙ, VGₙ₊₂, VGₙ₊₄..., VG_{n+2z}) is electrically connected to the first pixel group. The second row scan drive signal line (VGₙ₊₁, VGₙ₊₃, VGₙ₊₅..., VG₂ₙ₊₁) is electrically connected to the second pixel group. As shown in FIG. 4, each column of sub-pixels is divided into a third pixel group (Vp11ₙ₋ₘ, Vpn1ₙ₋ₘ... /Vp21ₙ₋ₘ... /Vp11ₙ₊₁₋ₘ, Vpn1ₙ₊₁₋ₘ...) and a fourth pixel group (Vp12ₙ₋ₘ, Vpn2ₙ₋ₘ... /Vp22ₙ₋ₘ... /Vp12ₙ₊₁₋ₘ, Vpn2ₙ₊₁₋ₘ...). The sub-pixels of the third pixel group and the fourth pixel group are arranged alternately along columns where they are located. Each of data drive signal lines (VDₘ, VDₘ₊₁, VDₘ₊₂..., VD_{m+z}) is connected to the third pixel group and the fourth pixel group of each column. Thus, the third pixel group of each column consists of sub-pixels of the first pixel group of the current column of each row, and the fourth pixel group of each column consists of sub-pixels of the second pixel group of the current column of each row. The sub-pixels of the first pixel group and the third pixel group are of a first polarity, and the sub-pixels of the second pixel group and the fourth pixel group are of a second polarity. n, m and z are greater than 1.

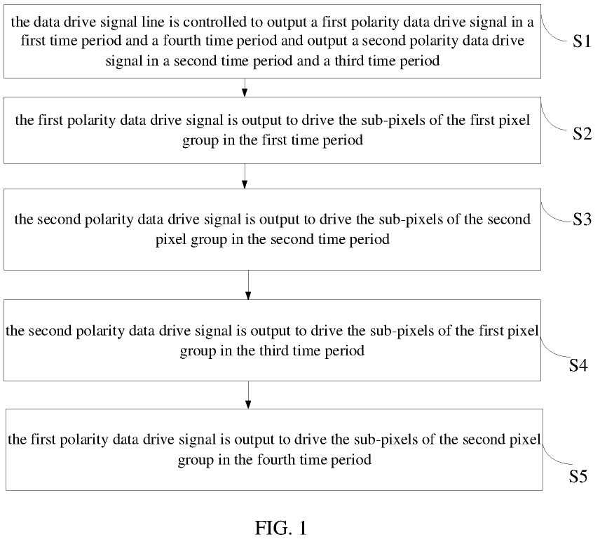

Referring to FIGS. 1 and 2, the driving method of the array substrate of the present application includes:
S1, the data drive signal line is controlled to output a first polarity data drive signal in a first time period and a fourth time period and output a second polarity data drive signal in a second time period and a third time period.
   The first polarity of the first polarity data drive signal and the second polarity of the second polarity data drive signal do not refer to a positive voltage or a negative voltage, but to voltages compared to a voltage of a common electrode of the array substrate, that is, the voltage of the first polarity data drive signal greater than that of the common electrode is of the first polarity, and the voltage of the second polarity data drive signal less than that of the common electrode is of the second polarity. The first time period, the second time period, the third time period, the fourth time period form a period. The data drive signal line outputs the first polarity data drive signal and the second polarity data drive signal alternately in a period.
S2, the first polarity data drive signal is output to drive the sub-pixels of the first pixel group in the first time period.
   Each of all data drive signal lines (VDₘ, VDₘ₊₁, VDₘ₊₂... VD_{m+z}) outputs the first polarity data drive signal to charge the sub-pixels of the first pixel group of each row. It should be noted that since the third pixel group of each column consists of sub-pixels of the first pixel group of the current column of each row, driving the first pixel group is also equivalent to driving the sub-pixels of the third pixel group of each column of the current row. That is, the sub-pixels of the first pixel group are the sub-pixels of the third pixel group on the overall display panel. The first pixel group and the third pixel group in the array substrate are driven by the first polarity, and pixels of the array substrate are arranged in such way that sub-pixels of the first polarity are arranged alternately along rows and columns where they are located. One brighter row of sub-pixels and one darker row of sub-pixels are avoided.
S3, the second polarity data drive signal is output to drive the sub-pixels of the second pixel group in the second time period.
   Each of all the data drive signal lines (VDₘ, VDₘ₊₁, VDₘ₊₂... VD_{m+z}) outputs the second polarity data drive signal to charge the sub-pixels of the second pixel group of each row. It should be noted that since the fourth pixel group of each column consists of sub-pixels of the second pixel group of the current column of each row, driving the second pixel group is also equivalent to driving the sub-pixels of the fourth pixel group of each column of the current row. That is, the sub-pixels of the second pixel group are the sub-pixels of the fourth pixel group on the overall display panel. At this time, the sub-pixels of the second pixel group of each row and that of the fourth pixel group of each column in the array substrate are driven by the second polarity. Since the sub-pixels of the first polarity lighted in a previous time period are slowly discharging, they gradually turn from bright to dark. Thus, the brightness of the overall array substrate gradually turns from bright to dark. When brighter, one bright row of sub-pixels and one darker row of sub-pixels won't happen. After the sub-pixels of the first polarity become darker, the pixels of the array substrate are arranged in such way that sub-pixels of the first polarity and the second polarity are arranged alternately along the rows and columns where they are located, thus one brighter row of sub-pixels and one darker row of sub-pixels are avoided.
S4, the second polarity data drive signal is output to drive the sub-pixels of the first pixel group in the third time period.
   Each of all the data drive signal lines (VDₘ, VDₘ₊₁, VDₘ₊₂... VD_{m+z}) outputs the second polarity data drive signal to charge the sub-pixels of the first pixel group of each row. It should be noted that since the third pixel group of each column consists of sub-pixels of the first pixel group of the current column of each row, driving the first pixel group is also equivalent to driving the sub-pixels of the third pixel group of each column of the current row. That is, the sub-pixels of the first pixel group are the sub-pixels of the third pixel group on the overall display panel. The sub-pixels of the first pixel group and the third pixel group in the array substrate are lighted, such that sub-pixels of the second polarity can be lighted continuously because sub-pixels lighted in the previous time period are also sub-pixels of the second polarity. Since the pixels of the array substrate are arranged in such way that the sub-pixels of the second polarity of the first pixel group and the second pixel group of each row are alternately arranged along rows and columns where they are located, thus one brighter row of sub-pixels and one darker row of sub-pixels are avoided.
S5, the first polarity data drive signal is output to drive the sub-pixels of the second pixel group in the fourth time period.
   Each of all the data drive signal lines (VDₘ, VDₘ₊₁, VDₘ₊₂... VD_{m+z}) outputs the first polarity data drive signal to charge the sub-pixels of the second pixel group of each row. It should be noted that since the fourth pixel group of each column consists of sub-pixels of the second pixel group of the current column of each row, driving the second pixel group is also equivalent to driving the sub-pixels of the fourth pixel group of each column of the current row. That is, the sub-pixels of the second pixel group are the sub-pixels of the fourth pixel group on the overall display panel. The sub-pixels of the second pixel group of each row and the fourth pixel group of each column in the array substrate are lighted. Since the sub-pixels of the second polarity lighted in the previous time are slowly discharging, they gradually turn from bright to dark. Thus, the brightness of the overall display panel gradually turns from bright to dark. When brighter, one bright row of sub-pixels and one darker row of sub-pixels wont' happen. After the sub-pixels of the second polarity become darker, the pixels of the array substrate are arranged in such way that the sub-pixels of the first polarity and the second polarity are alternately arranged along rows and columns where they are located, thus one brighter row of sub-pixels and one darker row of sub-pixels are avoided.
   According to the above solution, the sub-pixels of the third pixel group and the fourth pixel group of each column, connected to the data drive signal lines (VDₘ, VDₘ₊₁, VDₘ₊₂..., VD_{m+z}), are driven in the different time period, so that only the sub-pixels of the first polarity or the second polarity are driven in the same time period. The arrangement of sub-pixels of of the first polarity or the second polarity is combined with the driving solution to ensure the charging time for completely charging. One brighter row of sub-pixels and one darker row of sub-pixels are avoided. It should be noted that because time intervals among the first time period, the second time period, the third time period, and the fourth time period are basically less than the perception time of the user's eyes. Thus, the brightness change is difficultly perceived by the user, and a problem that the bright and dark streaks produce on the display panel is solved, and the user's use and the brightness adjustment function are not affected.

Referring to FIGS. 1 and 7, the driving method of the array substrate according to the present application may further include:
S6, the data drive signal line is controlled to output the first polarity data drive signal in the first time period and the second polarity data drive signal in the second time period.
   The first polarity of the first polarity data drive signal and the second polarity of the second polarity data drive signal do not refer to a positive voltage or a negative voltage, but to voltages compared to the voltage of the common electrode of the array substrate, that is, the voltage of the first polarity data drive signal greater than that of the common electrode is of the first polarity and the voltage of the second polarity data drive signal less than that of the common electrode is of the second polarity. The first time period and the second time period form a period. The data drive signal line outputs the first polarity data drive signal and the second polarity data drive signal alternately in a period.
   Similarly, in one embodiment, the voltage of the first polarity data drive signal greater than that of the common electrode is of the second polarity, and the voltage of the second polarity data drive signal less than that of the common electrode is of the first polarity.
S7, the first polarity data drive signal is output to drive sub-pixels of the first pixel group in the first time period.
   Each of all the data drive signal lines (VDₘ, VDₘ₊₁, VDₘ₊₂... VD_{m+z}) outputs the first polarity data drive signal to charge the sub-pixels of the first pixel group of each row. It should be noted that since the third pixel group of each column consists of sub-pixels of the first pixel group of the current column of each row, driving the first pixel group is also equivalent to driving the sub-pixels of the third pixel group of each column of the current row. That is, the sub-pixels of the first pixel group are exactly the sub-pixels of the third pixel group on the overall display panel. The sub-pixels of the first pixel group and the third pixel group in the array substrate are driven as the sub-pixels of the first polarity. Since the pixels of the array substrate are arranged in such way that the sub-pixels of the first polarity are alternately arranged along rows and columns where they are located, thus one bright row of sub-pixels and one darker row of sub-pixels are avoided.
S8, the second polarity data drive signal is output to drive the sub-pixels of the second pixel group in the second time period.
   Each of all the data drive signal lines (VDₘ, VDₘ₊₁, VDₘ₊₂... VD_{m+z}) outputs the second polarity data drive signal to charge the sub-pixels of the second pixel group of each row and the sub-pixels of the fourth pixel group of each column. It should be noted that since the fourth pixel group of each column consists of sub-pixels of the second pixel group of the current column of each row, driving the second pixel group is also equivalent to driving the sub-pixels of the fourth pixel group of each column of the current row. That is, the sub-pixels of the second pixel group are exactly the sub-pixels of the fourth pixel group on the overall display panel. The sub-pixels of the second pixel group of each row and that of the fourth pixel group of each column in the array substrate are driven by the second polarity. Since the sub-pixels of the first polarity lighted in the previous time are slowly discharging, they gradually turn from bright to dark. Thus, the brightness of the overall display panel gradually turns from bright to dark. When brighter, one bright row of sub-pixels and one darker row of sub-pixels wont' happen. After the sub-pixels of the first polarity become darker, the pixels of the array substrate are arranged in such way that the sub-pixels of the first polarity and the second polarity are alternately arranged along rows and columns where they are located, thus one brighter row of sub-pixels and one darker row of sub-pixels are avoided.

According to the above solution, the sub-pixels of the third pixel group and the fourth pixel group of each column, connected to the data drive signal lines (VDₘ, VDₘ₊₁, VDₘ₊₂..., VD_{m+z}), are driven in the different time period, so that only the sub-pixels of a positive second polarity are driven in a certain time period. The arrangement of sub-pixels of the positive second polarity is combined with the driving solution to ensure the charging time for completely charging. One brighter row of sub-pixels and one darker row of sub-pixels are avoided. The bright and dark streaks easily produced on the display panel are avoided. It should be noted that because a time interval from the first time period to the second time period is basically less than the perception time of the user's eyes. Thus, the brightness change is difficultly perceived by the user, and a problem that the bright and dark streaks produce on the display panel is solved, and the user's use and the brightness adjustment function are not affected.

In one embodiment, when the data drive signal line is controlled to output the first polarity data drive signal and the second polarity data drive signal alternately in the first time period, the second time period, the third time period, and the fourth time period, the time spans of the first time period, the second time period, the third time period, and the fourth time period are equal.

It is ensured that time spans are equal, which can ensure the display homogeneity of the whole display panel. One brighter row of sub-pixels and one darker row of sub-pixels won't happen, and the brightness deviation of the display panel at all the time spans can be reduced.

In one embodiment, the operation of outputting the first polarity data drive signal to drive the sub-pixels of the first pixel group includes:
crossing the row scan drive signal lines (VGₙ, VGₙ₊₁, VGₙ₊₂, VGₙ₊₃, VGₙ₊₄, VGₙ₊₅,..., VG_{n+z}) in turn along an extension direction of the data drive signal lines to drive the sub-pixels of the first pixel group of each row.
The sub-pixels of the first pixel group of each row are driven in the extension direction of the data drive signal line crossing the row scan drive signal line (VGₙ, VGₙ₊₁, VGₙ₊₂, VGₙ₊₃, VGₙ₊₄, VGₙ₊₅... VG_{n+z}) in turn, the sub-pixels of the first pixel group of each row are thus charged and lighted row by row to effectively avoid that there is an unlighted sub-pixel, and the stability of uniform display is improved.

In one embodiment, the operation of outputting the first polarity data drive signal to drive the sub-pixels of the second pixel group includes:

driving the sub-pixels of the second pixel group of each row in turn along the extension direction of the data drive signal lines (VDₘ, VDₘ₊₁, VDₘ₊₂... VD_{m+z}).

The sub-pixels of the second pixel group of each row are driven along the extension direction of the data drive signal lines (VDₘ, VDₘ₊₁, VDₘ₊₂... VD_{m+z}) crossing the row scan drive signal lines (VGₙ, VGₙ₊₁, VGₙ₊₂, VGₙ₊₃, VGₙ₊₄, VGₙ₊₅...) in turn, so that the sub-pixels of the second pixel group of each row are charged and lighted row by row to effectively avoid that there is an unlighted sub-pixel, and the stability of uniform display is improved.

To achieve the above purpose, the present application also proposes an array substrate. The array substrate includes a memory, a processor, a plurality of sub-pixels and data drive signal lines. As shown in FIGS. 2 and FIG.4, the plurality of sub-pixels are arranged in an array. Each row of sub-pixels is divided into a first pixel group (Vp11ₙ₋ₘ, Vp11ₙ₊₁₋ₘ ...., Vp11_{n+z-m}/Vp21ₙ₋ₘ, Vp21ₙ₊₁₋ₘ ...., Vp21_{n+z-m}/Vpn1ₙ₋ₘ, Vpn1ₙ₊₁₋ₘ...., Vpn1_{n+z-m}) and a second pixel group (Vp12ₙ₋ₘ, Vp12ₙ₊₁₋ₘ ...., Vp12_{n+z-m}/Vp22ₙ₋ₘ, Vp22n+1-m...., Vp22n+n-m/Vpn2n-m, Vpn2ₙ₊₁₋ₘ...., Vpn2_{n+z-m}). The sub-pixels of the first pixel group and the second pixel group are arranged alternately along rows where they are located. Each row of sub-pixels has a first row scan drive signal line (VGₙ, VGₙ₊₂, VGₙ₊₄..., VG_{n+2z}) and a second row scan drive signal line (VGₙ₊₁, VGₙ₊₃, VGₙ₊₅..., VG₂ₙ₊₁). In the same row, the first row scan drive signal lines are electrically connected to the first pixel group. The second row scan drive signal lines are electrically connected to the second pixel group. Each column of sub-pixels includes a third pixel group (Vp11ₙ₋ₘ, Vpn1ₙ₋ₘ... /Vp21ₙ₋ₘ... /Vp11ₙ₊₁₋ₘ, Vpn1ₙ₊₁₋ₘ...) and a fourth pixel group (Vp12ₙ₋ₘ, Vpn2ₙ₋ₘ... /Vp22ₙ₋ₘ... /Vp12ₙ₊₁₋ₘ, Vpn2ₙ₊₁₋ₘ...). The sub-pixels of the third pixel group and the fourth pixel group are arranged alternately along columns where they are located. Each of data drive signal lines is connected to the third pixel group and the fourth pixel group of each column.

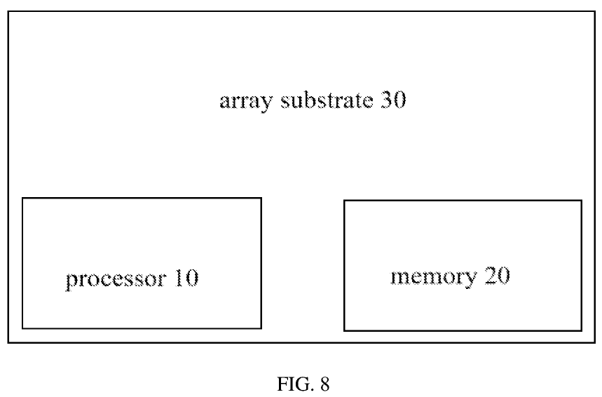

As shown in FIG. 8, the array substrate 30 includes a processor 10 and a memory 20 storing a driving program of the array substrate 30, the driving program of the array substrate 30 is operatable on the processor 10, when the driving program of the array substrate 30 is executed by the processor, a driving method of the array substrate 30 as mentioned above is realized.

The third pixel group of each column consists of sub-pixels of the first pixel group of a corresponding column of each row, and the fourth pixel group of each column consists of sub-pixels of the second pixel group of a corresponding column of each row. Thus, the sub-pixels of the first pixel group and third pixel group are of the first polarity, and the sub-pixels of the second pixel group and fourth pixel group are of the second polarity.

It should be noted that since the array substrate of the present application includes all the embodiments of the above-mentioned driving method of the array substrate, the array substrate of the present application has all the beneficial effects of the above-mentioned driving method of the array substrate, which will not be repeated herein.

In one embodiment, the array substrate further includes a plurality of data drive signal lines (VDₘ, VDₘ₊₁, VDₘ₊₂...,VD_{m+z}), a plurality of the sub-pixels are divided into groups according to two adjacent columns of sub-pixels as a group. Each of the data drive signal lines is provided between two columns of sub-pixels of each group and electrically connected to each sub-pixel of two columns of sub-pixels of each group.

The two columns of sub-pixels in one group have two data drive signal lines, while in this embodiment, two columns of sub-pixels are driven simultaneously by only one data drive signal line (VDₘ, VDₘ₊₁, VDₘ₊₂... VD_{m+z}), thus the overall number of data drive signal lines of the array substrate is reduced, and the stability of uniform display of the array substrate can be ensured.

In one embodiment, as shown in FIG. 2 and FIG. 4, the array substrate further includes a plurality of common electrode signal lines (Vₛₜₓ, Vₛₜₓ₊₁..., V_{stx+z}), each of which is provided between two adjacent groups of sub-pixels. stz, z are greater than 1.

In each column of sub-pixels, a common electrode storage capacitance Cst is formed between each of the sub-pixels and the adjacent common electrode signal line.

By the above solution, the opening rate of the display panel is increased, so that the effective light-emitting area of each of sub-pixels is greatly improved, the penetration rate is increased, and the brightness is increased. By combining the above solution with the driving method of the display panel, the overall brightness of the display panel can be improved under the same driving voltage.

In one embodiment, referring to FIG. 5, electrical connection of the common electrode storage capacitor Cst is described below. One terminal of each common electrode storage capacitor Cst is connected to a corresponding common electrode signal line (Vₛₜₓ, Vₛₜₓ₊₁... V_{stx+z}), and the other terminal of each common electrode storage capacitor Cₛₜ is connected to the pixel electrode C_{LC} of the corresponding sub-pixel.

In one embodiment, on a row of sub-pixels of the array substrate, three sub-pixels form a pixel unit. Three sub-pixels are a red sub-pixel, a green sub-pixel and a blue sub-pixel in turn. One of a data drive signal line and a common electrode signal line is provided between the red sub-pixel and the green sub-pixel and the other of the data drive signal line and the common electrode signal line is provided between the blue sub-pixel and the green sub-pixel.

With the above solution, it is possible to ensure that a number of sub-pixels of the first polarity and a number of sub-pixels of the second polarity driven by the data drive signal lines are balance, and numbers of the three primary colors are also maintained balance to avoid color differences in the final color rendering.

In one embodiment, when there is a plurality of the pixel units, one of the data drive signal line and the common electrode signal line may also be provided between the red sub-pixel of the next pixel unit and the blue sub-pixel of the current pixel unit.

With the above solution, it is possible to ensure that a number of sub-pixels of the first polarity and a number of the second polarity driven by the data drive signal line are balance, and numbers of the three primary colors are also maintained balance to avoid color differences in the final color rendering.

In one embodiment, in a row of sub-pixels of the array structure, four sub-pixels form a pixel unit, and the four sub-pixels are a red sub-pixel, a green sub-pixel, a blue sub-pixel and a white sub-pixel in turn. One of the data drive signal line and the common electrode signal line is provided between the red sub-pixel and the green sub-pixel and the other of the data drive signal line and the common electrode signal line is provided between the green sub-pixel and the blue sub-pixel.

With the above solution, it is possible to ensure that a number of sub-pixels of the first polarity and a number of the second polarity driven by the data drive signal lines are balance, and numbers of the three primary colors are balance and complementary light is also maintained balance to avoid the color difference and the brightness difference in the final color rendering. The display homogeneity is ensured and the formation of dark and bright stripes is avoided.

In one embodiment, when there is a plurality of the pixel units, one of the data drive signal line and the common electrode signal line may also be provided between the red sub-pixel of the next pixel unit and the blue sub-pixel of the current pixel unit, between the red sub-pixel and the white sub-pixel, or between the blue sub-pixel and the white sub-pixel.

With the above solution, it is possible to ensure that numbers of sub-pixels of the first polarity and of the second polarity driven by the data drive signal lines of the array substrate are balance and the complementary light is balance, and the three primary colors are also maintained balance to avoid the color difference and the brightness difference in the final color rendering. The balance of the display is ensured and the formation of dark and bright stripes is avoided.

The present application also proposes a display panel. The display panel includes a color film substrate, a liquid crystal and an array substrate as described above, the array substrate, the liquid crystal and the color film substrate are stacked in turn.

It is worth noting that because the display panel of the present application contains all the above-mentioned embodiments of the array substrate, the display panel of the present application has all the beneficial effects of the above-mentioned array substrate, which will not be repeated here.

The above is only an optional embodiment of the present application, not to limit the claimed scope of the present application. Any equivalent structural transformation made by using the contents of the specification and the attached drawings of the present application under the concept of the present application, or any direct or indirect application in other related technical fields is included in the claimed scope of the present application.

1. A driving method of an array substrate, wherein the array substrate comprises:
a plurality of sub-pixels arranged in an array;
wherein each row of sub-pixels comprises a first pixel group and a second pixel group, sub-pixels of the first pixel group and sub-pixels of the second pixel group are arranged alternately in the row, each row of sub-pixels has a first row scan drive signal line and a second row scan drive signal line; in a same row, the first row scan drive signal line is electrically connected to the first pixel group and the second row scan drive signal line is electrically connected to the second pixel group;
wherein each column of sub-pixels comprises a third pixel group and a fourth pixel group, sub-pixels of the third pixel group and the fourth pixel group are arranged alternately in the column, a data drive signal line is electrically connected to the third pixel group and the fourth pixel group of each column;
wherein sub-pixels of the first pixel group and sub-pixels of the third pixel group are of a first polarity and sub-pixels of the second pixel group and sub-pixels of the fourth pixel group are of a second polarity;
wherein the driving method of the array substrate comprises:
controlling the data drive signal line to output a first polarity data drive signal in a first time period and a fourth time period, and output a second polarity data drive signal in a second time period and a third time period;
outputting the first polarity data drive signal to drive the sub-pixels of the first pixel group in the first time period;
outputting the second polarity data drive signal to drive the sub-pixels of the second pixel group in the second time period;
outputting the second polarity data drive signal to drive the sub-pixels of the first pixel group in the third time period; and
outputting the first polarity data drive signal to drive the sub-pixels of the second pixel group in the fourth time period; or
the driving method of the array substrate comprises:
controlling the data drive signal line to output the first polarity data drive signal in the first time period and the second polarity data drive signal in the second time period;
outputting the first polarity data drive signal to drive the sub-pixels of the first pixel group in the first time period; and
outputting the second polarity data drive signal to drive the sub-pixels of the second pixel group in the second time period.

2. The driving method of the array substrate according to claim 1, wherein the outputting the first polarity data drive signal to drive the sub-pixels of the first pixel group comprises:
driving the sub-pixels of the first pixel group of each row in turn along an extension direction of the data drive signal line.

3. The driving method of the array substrate according to claim 1, wherein the outputting the second polarity data drive signal to drive the sub-pixels of the second pixel group comprises:
driving the sub-pixels of the second pixel group of each row in turn along an extension direction of the data drive signal line.

4. The driving method of the array substrate according to claim 1, wherein when the data drive signal line is controlled to output the first polarity data drive signal in the first time period and the fourth time period, and output the second polarity data drive signal in the second time period and the third time period, time spans of the first time period, the second time period, the third time period and the fourth time period are equal; or
when the data drive signal line is controlled to output the first polarity data drive signal in the first time period and the second polarity data drive signal in the second time period, time spans of the first time period and the second time period are equal.

5. An array substrate, comprising a memory storing a driving program of the array substrate; and a processor for executing the driving program of the array substrate to realize a driving method,
wherein the array substrate comprises:
a plurality of sub-pixels arranged in an array;
wherein each row of sub-pixels comprises a first pixel group and a second pixel group, sub-pixels of the first pixel group and sub-pixels of the second pixel group are arranged alternately in the row, each row of sub-pixels has a first row scan drive signal line and a second row scan drive signal line, wherein in a same row, the first row scan drive signal line is electrically connected to the first pixel group and the second row scan drive signal line is electrically connected to the second pixel group;
wherein each column of sub-pixels comprises a third pixel group and a fourth pixel group, sub-pixels of the third pixel group and the fourth pixel group are arranged alternately in the column, a data drive signal line is electrically connected to the third pixel group and the fourth pixel group of each column;
wherein sub-pixels of the first pixel group and sub-pixels of the third pixel group are of a first polarity and sub-pixels of the second pixel group and sub-pixels of the fourth pixel group are of a second polarity;
wherein the driving method of the array substrate comprises:
controlling the data drive signal line to output a first polarity data drive signal in a first time period and a fourth time period, and output a second polarity data drive signal in a second time period and a third time period;
outputting the first polarity data drive signal to drive the sub-pixels of the first pixel group in the first time period;
outputting the second polarity data drive signal to drive the sub-pixels of the second pixel group in the second time period;
outputting the second polarity data drive signal to drive the sub-pixels of the first pixel group in the third time period; and
outputting the first polarity data drive signal to drive the sub-pixels of the second pixel group in the fourth time period; or
the driving method of the array substrate comprises:
controlling the data drive signal line to output the first polarity data drive signal in the first time period and the second polarity data drive signal in the second time period;
outputting the first polarity data drive signal to drive the sub-pixels of the first pixel group in the first time period; and
outputting the second polarity data drive signal to drive the sub-pixels of the second pixel group in the second time period.

6. The array substrate according to claim 5, wherein the array substrate further comprises a plurality of data drive signal lines, the plurality of the sub-pixels are divided into a plurality of groups by two adjacent columns of sub-pixels as a group, each of the data drive signal lines is provided between two columns of sub-pixels of each group and electrically connected to each sub-pixel of the two columns of sub-pixels of each group.

7. The array substrate according to claim 5, wherein the array substrate further comprises a plurality of common electrode signal lines, each of the common electrode signal lines is provided between two adjacent groups of sub-pixels;
wherein in each column of sub-pixels, a common electrode storage capacitance Cst is formed by each sub-pixel and an adjacent common electrode signal line.

8. The array substrate according to claim 7, wherein one terminal of the common electrode storage capacitor is connected to the common electrode signal line, and the other terminal of the common electrode storage capacitor is connected to a pixel electrode of the sub-pixel.

9. The array substrate according to claim 5, wherein on a row of sub-pixels of the array substrate, three sub-pixels form a pixel unit, the three sub-pixels comprise a red sub-pixel, a green sub-pixel and a blue sub-pixel in turn, wherein one of a data drive signal line and a common electrode signal line is provided between the red sub-pixel and the green sub-pixel, and the other of the data drive signal line and the common electrode signal line is provided between the blue sub-pixel and the green sub-pixel.

10. The array substrate according to claim 5, wherein the outputting the first polarity data drive signal to drive the sub-pixels of the first pixel group comprises:
driving the sub-pixels of the first pixel group of each row in turn along an extension direction of the data drive signal line.

11. The array substrate according to claim 5, wherein the outputting the second polarity data drive signal to drive the sub-pixels of the second pixel group comprises:
driving the sub-pixels of the second pixel group of each row in turn along an extension direction of the data drive signal line.

12. The array substrate according to claim 5, wherein when the data drive signal line is controlled to output the first polarity data drive signal in the first time period and the fourth time period, and output the second polarity data drive signal in the second time period and the third time period, time spans of the first time period, the second time period, the third time period and the fourth time period are equal; or
when the data drive signal line is controlled to output the first polarity data drive signal in the first time period and the second polarity data drive signal in the second time period, time spans of the first time period and the second time period are equal.

13. A display panel, comprising a color film substrate, a liquid crystal, and an array substrate, wherein the array substrate, the liquid crystal, and the color film substrate are stacked in turn, wherein the array substrate comprises:
a plurality of sub-pixels arranged in an array;
wherein each row of sub-pixels comprises a first pixel group and a second pixel group, sub-pixels of the first pixel group and sub-pixels of the second pixel group are arranged alternately in the row, each row of sub-pixels has a first row scan drive signal line and a second row scan drive signal line, wherein in a same row, the first row scan drive signal line is electrically connected to the first pixel group and the second row scan drive signal line is electrically connected to the second pixel group;
wherein each column of sub-pixels comprises a third pixel group and a fourth pixel group, sub-pixels of the third pixel group and the fourth pixel group are arranged alternately in the column, a data drive signal line is electrically connected to the third pixel group and the fourth pixel group of each column;
wherein sub-pixels of the first pixel group and sub-pixels of the third pixel group are of a first polarity and sub-pixels of the second pixel group and sub-pixels of the fourth pixel group are of a second polarity;
wherein when the data drive signal line is controlled to output the first polarity data drive signal in the first time period and the fourth time period, and output the second polarity data drive signal in the second time period and the third time period, time spans of the first time period, the second time period, the third time period and the fourth time period are equal; or
when the data drive signal line is controlled to output the first polarity data drive signal in the first time period and the second polarity data drive signal in the second time period, time spans of the first time period and the second time period are equal.

14. The display panel according to claim 13, wherein the array substrate further comprises a plurality of data drive signal lines, the plurality of the sub-pixels are divided into a plurality of groups with two adjacent columns of sub-pixels being a group, each of the data drive signal lines is provided between two columns of sub-pixels of each group and electrically connected to each sub-pixel of the two columns of sub-pixels of each group.

15. The display panel according to claim 13, wherein the array substrate further comprises a plurality of common electrode signal lines, each of the common electrode signal lines is provided between two adjacent groups of sub-pixels;
wherein in each column of sub-pixels, a common electrode storage capacitance Cst is formed by each sub-pixel and an adjacent common electrode signal line.

16. The display panel according to claim 15, wherein one terminal of the common electrode storage capacitor is connected to the common electrode signal line, and the other terminal of the common electrode storage capacitor is connected to a pixel electrode of the sub-pixel.

17. The display panel according to claim 13, wherein on a row of sub-pixels of the array substrate, three sub-pixels form a pixel unit, the three sub-pixels comprise a red sub-pixel, a green sub-pixel and a blue sub-pixel in turn, wherein one of a data drive signal line and a common electrode signal line is provided between the red sub-pixel and the green sub-pixel, and the other of the data drive signal line and the common electrode signal line is provided between the blue sub-pixel and the green sub-pixel.
